(19) United States
(12) Patent Application Publication
(10) Pub. No.: US 2007/0107712 A1
(43) Pub. Date: May 17, 2007

(54) Heating cooker

(75) Inventors: Yukishige Shiraichi, Yao-Shi (JP); Masaki Ohtsuka, Osaka-Shi (JP)

Correspondence Address: BIRCH STEWART KOLASCH & BIRCH, PO BOX 747, FALLS CHURCH, VA, 22040-0747, US

(73) Assignee: SHARP KABUSHIKI KAISHA, Osaka (JP)

(21) Appl. No.: 10/555,671

(22) PCT Filed: May 10, 2004
(86) PCT No.: PCT/JP04/06587

§ 371 Date: Nov. 3, 2005

(30) Foreign Application Priority Data
May 15, 2003 (JP) 2003-137436
Mar. 1, 2004 (JP) 2004-55677

(51) Int. Cl. F24C 15/32; F27D 11/00

(52) U.S. Cl. 126/21 A; 99/352; 219/400

(57) ABSTRACT

A heating cooker has an air-sucking opening (36) at one side of opposed edge portions of an inner wall (31) and an air-blowing opening (37) at the other side. Heated air sent into a heating room (3) from the blowing opening (37) flows along three inner walls (32, 4 (door), 33) and sucked from the sucking opening (36). This structure enables the heated air to pervade the entire heating room (3). As a result, temperature variations in the heating room (3) are suppressed to a low level and an object to be heated is evenly baked.

### TECHNICAL FIELD

The present invention relates to a heating cooker, more particularly to a so-called hot air circulation heating cooker that makes a hot air circulate so as to cook an article to be heated.

### BACKGROUND ART

Heating cookers such as convection ovens using hot air circulation to cook an article to be heated that is put in the heating chamber are provided with a blower (blowing means) for producing forced circulation of the air inside the heating chamber and a heater (heating means) for heating the circulated air, so as to speed up cooking time and make the temperature inside the chamber uniform, and thereby achieve improved heating performance. When the heating cooker is used, it is necessary to appropriately set the temperature inside the heating chamber, the cooking time, and the like. Some models of heating cookers have, as well as an oven cooking function, an electromagnetic wave heating function, a dielectric heating function, and a steam cooking function, or have a combination of cooking functions such as oven, electromagnetic wave heating, dielectric heating, and steam functions.

A front perspective view of a typical example of a conventional heating cooker is shown in FIG. 23, and a plan sectional view thereof is shown in FIG. 24. The heating cooker 1′ shown in this figure has a cabinet 2 that is insulated with an insulating member, a heating chamber 3 that is formed inside the cabinet 2 to permit an article to be heated S to be placed therein, a fan casing 8 (shown in FIG. 24) that is formed at the back of a side wall 31 of the heating chamber 3, a centrifugal fan (blowing means) 6 that is arranged inside the fan casing 8, and a ring-shaped heater (heating means) 7 that is disposed concentrically with the rotation axis of the centrifugal fan 6. The heating chamber 3 has, at the center of the side wall 31 thereof, a suction port 36, and has, in a region surrounding the suction port 36, a blowoff port 37. The suction port 36 and the blowoff port 37 communicate with each other via the fan casing 8 (see, for example, Japanese Patent Application Laid-Open No. S62-268919 (pages 1 to 2, upper left column, and FIGS. 17 and 18)).

In the heating cooker 1′ structured as described above, when the article to be heated S is placed in the heating chamber 3 and then heating operation is started, the centrifugal fan 6 is rotated by the motor M. The air inside the heating chamber 3 is thus sucked in via the suction port 36 into the fan casing 8, is then sent outward in the direction of the radius of the centrifugal fan 6, and is then, after being heated by the heater 7, blown back into the heating chamber 3 through the blowoff port 37.

In this conventional heating cooker 1′, as indicated by arrows in FIG. 24, the flow of air that is produced by the centrifugal fan 6 and that circulates inside the heating chamber 3 mainly occurs in the vicinity of the blowoff port 37 and the suction port 36. This makes it difficult to make the hot air that blows out therefrom reach a position away from the blowoff port 37 and the suction port 36. Therefore, as can be seen in FIG. 25 showing the temperature distribution map, the temperature inside the heating chamber 3 decreases with distance from the blowoff port 37 and the suction port 36. The problem here is that such unevenness in the temperature inside the heating chamber 3 results in uneven cooking of the article to be heated S depending on where it is placed in the heating chamber 3.

Thus, as shown in FIG. 26, the blowing capacity of the centrifugal fan 6 and the output of the heater 7 may be so increased that the hot air can reach a position away from the blowoff port 37 and the suction port 36. However, in that case, the following problems arise. As shown in FIG. 27, the flow of air that flows to the suction port 36 inside the heating chamber 3 occurs at the center of the heating chamber 3 in a concentrated manner, leading to uneven cooking of the article to be heated S even at the center of the heating chamber 3 where it is placed. Moreover, such a flow of air to the suction port 36 that occurs at the center of the heating chamber 3 in a concentrated manner results in uneven cooking of the article to be heated S depending on where it is placed in the heating chamber 3 due to the influence of the flow of the hot air.

In view of the conventionally experienced problems described above, it is an object of the present invention to provide a heating cooker that is a hot air circulation heating cooker, and that can uniformly send a hot air into a heating chamber and thereby prevent uneven cooking of an article to be heated S.

### DISCLOSURE OF THE INVENTION

As a result of an intensive study with a view to achieving the above object, the inventors of the present invention have found out that it is possible to make a hot air flow uniformly inside the heating chamber by exploiting the property of fluid such as air, that is, the tendency of fluid to flow along an article that is placed in a stream of fluid (the Coanda effect). This finding has led the inventors to the present invention.

Specifically, according to a first invention, a heating cooker is characterized in that a hot air blown out through a blowoff port is made to flow continuously along at least three inner walls constituting a heating chamber. This makes it possible to make the hot air spread to every corner of the heating chamber, and thus helps minimize unevenness in the temperature inside the heating chamber.

Here, from the viewpoint of making the hot air spread effectively to every corner of the heating chamber, it is preferable that the blowoff port be formed in an edge portion of at least one inner wall constituting the interior of the heating chamber, and, in addition, that the suction port be formed in the opposite edge portion of the inner wall.

Moreover, from the viewpoint of making the heating cooker compact, and from the viewpoint of making wider the same temperature range in the center of the heating chamber by making the air that has just been blown out through the blowoff port and has a comparatively high temperature localized in the back corner of the heating chamber, it is preferable that a projecting portion be formed in at least one inner wall constituting the interior of the heating chamber, that the suction port be formed in the top face of the projecting portion, and that the blowoff port be formed in a side face thereof. At this time, the projecting portion may be so formed as to have quadrangular bottom and top faces when viewed in a plan view and have a cross-sectional area gradually decreasing from the bottom face toward the top face, and the blowoff port may be formed in one of the side faces of the projecting portion. Alternatively, the projecting portion may be so formed as to have quadrangular bottom and top faces, one side of each being a circular arc, and have a cross-sectional area gradually decreasing from the bottom face toward the top face, and the blowoff port may be formed in a curved face constituting one of the side faces of the projecting portion.

Moreover, according to a second invention, a heating cooker is characterized in that mutually opposite two inner walls, which constitute a heating chamber, each have a blowoff port and a suction port in such a way that the blowoff port formed in each of the two inner walls faces the suction port formed in the other of the two inner walls. With this structure, the hot air introduced through one blowoff port into the heating chamber flows in a substantially linear manner, and is then sucked via the opposite suction port thereof. Then, the hot air is introduced through another blowoff port into the heating chamber, then again flows in a substantially linear manner, and is then sucked via the opposite suction port thereof. This makes the hot air circulate completely throughout the heating chamber. This makes it possible to apply heat uniformly to an article to be heated especially in the depth direction.

Moreover, according to a third invention, a heating cooker is characterized in that a blowoff port is formed in a side wall of a heating chamber, and a suction port is formed in at least one or both of a ceiling and a bottom wall thereof. With this structure, the hot air introduced through the blowoff port into the heating chamber flows upward or downward in a spiral manner along the side wall of the heating chamber, and is then sucked via the suction port. This also makes it possible to make the hot air spread to every comer of the heating chamber, and thus helps minimize unevenness in the temperature inside the heating chamber.

From the viewpoint of making the hot air flow along the side wall without fail, when the interior of the heating chamber is quadrangular when viewed in a plan view, it is preferable that the blowoff port be formed in a right or left edge portion of the side wall when viewed from the center of the heating chamber. Moreover, from the viewpoint of making the hot air circulate more uniformly throughout the heating chamber, it is preferable that the blowoff port be formed in each of all side walls of the heating chamber in an edge portion thereof at the same side.

### BRIEF DESCRIPTION OF DRAWINGS

FIG. 1 is a front perspective view showing one embodiment of the heating cooker of a first invention;

FIG. 2 is a plan sectional view of the heating cooker of FIG. 1;

FIG. 3 is a map showing the temperature distribution inside the heating chamber of the heating cooker of FIG. 1;

FIG. 4 is a front perspective view showing another embodiment of the heating cooker of the first invention;

FIG. 5 is a front perspective view showing still another embodiment of the heating cooker of the first invention;

FIG. 6 is a front perspective view showing still another embodiment of the heating cooker of the first invention;

FIG. 7 is a front perspective view showing another embodiment of the heating cooker of the first invention;

FIG. 8 is a plan sectional view of the heating cooker of FIG. 7;

FIG. 9 is a map showing the temperature distribution inside the heating chamber of the heating cooker of FIG. 7;

FIG. 10 is a front perspective view showing another embodiment of the heating cooker of the first invention;

FIG. 11 is a plan sectional view of the heating cooker of FIG. 10;

FIG. 12 is a map showing the temperature distribution inside the heating chamber of the heating cooker of FIG. 10;

FIG. 13 is a front perspective view showing another embodiment of the heating cooker of the first invention;

FIG. 14 is a front perspective view of the heating cooker of FIG. 13, with the blowoff port placed in a different position from in FIG. 13;

FIG. 15 is a front perspective view of the heating cooker of FIG. 13, with the blowoff port placed in a different position from in FIG. 13;

FIG. 16 is a front perspective view showing one embodiment of the heating cooker of a second invention;

FIG. 17 is a plan sectional view of the heating cooker of FIG. 16;

FIG. 18 is a map showing the temperature distribution inside the heating chamber of the heating cooker of FIG. 16;

FIG. 19 is a front perspective view showing the structure of the heating cooker of a third invention;

FIG. 20 is a plan sectional view of the heating cooker of FIG. 19;

FIG. 21 is a front perspective view showing how a hot air flows inside the heating chamber of the heating cooker of FIG. 19;

FIG. 22 is a map showing the temperature distribution inside the heating chamber of the heating cooker of FIG. 19;

FIG. 23 is a front perspective view showing the structure of a conventional heating cooker;

FIG. 24 is a plan sectional view of the heating cooker of FIG. 23;

FIG. 25 is a map showing the temperature distribution inside the heating cooker of FIG. 23;

FIG. 26 is a plan sectional view showing another structure of the conventional heating cooker; and

FIG. 27 is a map showing the temperature distribution inside the heating chamber of the heating cooker of FIG. 26.

### BEST MODE FOR CARRYING OUT THE INVENTION

Hereinafter, a heating cooker of the present invention will be described with reference to the drawings. It is to be understood, however, that the present invention is not limited to any of the examples specifically described below.

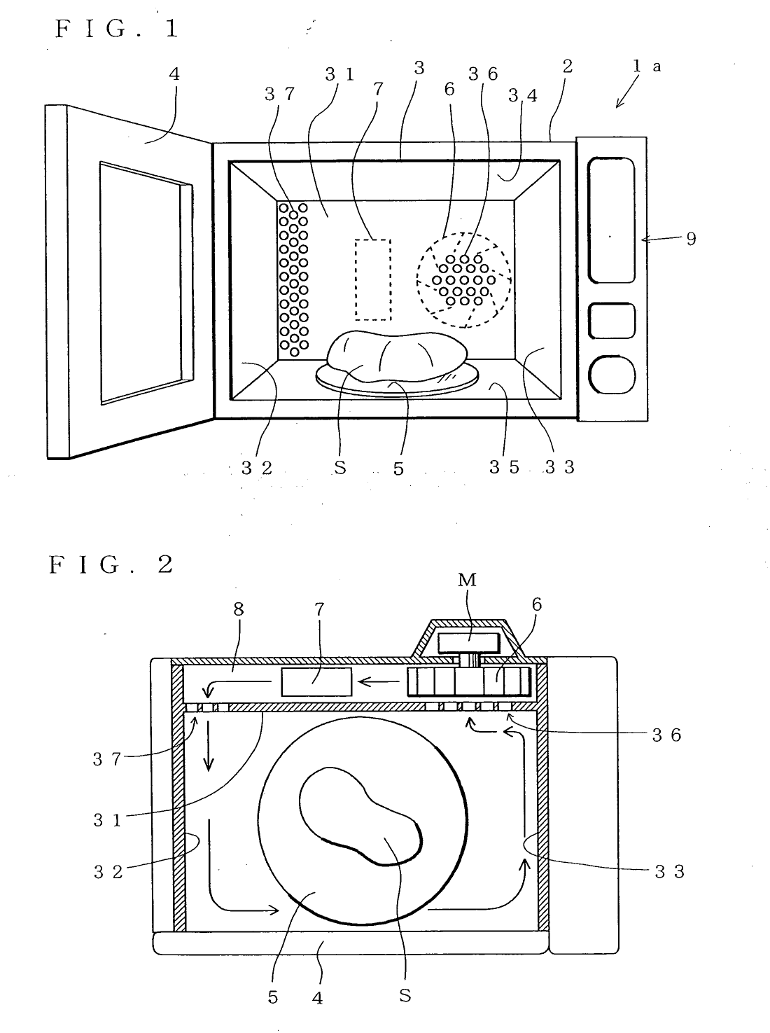

A front perspective view showing one embodiment of the heating cooker of a first invention is shown in FIG. 1, and a plan sectional view thereof is shown in FIG. 2. This heating cooker 1a has a cabinet 2 that is insulated with insulating means and that has an opening at the front face thereof, a heating chamber 3 that is formed inside the cabinet 2 to permit an article to be cooked to be placed therein, a door 4 that openably closes the opening, and an operation portion 9 that receives/displays cooking conditions.

The heating chamber 3 has, in the bottom wall thereof, a hole (not shown), through which a rotation axis (not shown) is projected. On top thereof, a turntable 5 is provided for mounting an article to be heated S thereon. Moreover, the heating chamber 3 has a side wall 31 having, on the right side thereof when viewed from the front, a suction port 36 that has substantially the shape of a circle and is composed of punched holes each having a diameter of 5 mm, and, on the left side thereof, a blowoff port 37 that has substantially the shape of a rectangle and is composed of punched holes. As can be seen in FIG. 2, the side wall 31 has a fan casing 8 formed at the back thereof. Via the fan casing 8, the suction port 36 and the blowoff port 37 communicate with each other. Inside the fan casing 8, a centrifugal fan (blowing means) 6 supported by a motor M is so placed as to face the suction port 36. There is formed a heater (heating means) 7 between the centrifugal fan 6 and the blowoff port 37.

In the heating cooker 1a structured as described above, when the user mounts the article to be heated S on the turntable 5 and then inputs appropriate cooking conditions to the operation portion 9, the motor M is driven based on these cooking conditions received from the operation portion 9 so as to rotate the centrifugal fan 6, and the heater 7 is activated. In this way, cooking of the article to be heated S is started.

As shown in FIG. 2, when cooking is started, the centrifugal fan 6 is rotated, and the air inside the heating chamber 3 is sucked in via the suction port 36 into the fan casing 8. The air thus sucked in is blown out in the direction of the radius of the centrifugal fan 6. The air blown out from the centrifugal fan 6 is heated by the heater 7, and is then blown out through the blowoff port 37 formed in the edge portion of the side wall 31 into the heating chamber 3. As indicated by arrows in FIG. 2, the hot air that has been blown out flows continuously, by the Coanda effect, along a side wall 32, the door 4, and a side wall 33. Specifically, the hot air blown out through the blowoff port 37 first flows to the door 4 along the left side wall 32 of the heating chamber 3, then flows to the right side wall 33 of the heating chamber 3 along the door 4, and then flows along the right side wall 33 of the heating chamber 3. Finally, it is sucked in again via the suction port 36 formed in the side wall 31 of the heating chamber 3, and then circulates in this way. Note that the door 4 in its closed state serves as one of the inner walls of the heating chamber 3.

In this way, the hot air is made to flow and circulate along the side walls 31, 32, and 33 of the heating chamber 3 and the door 4. This makes it possible to make the temperature inside the heating chamber 3 uniform. At the same time, unlike conventional examples, it is possible to prevent the hot air from being concentrated at the center of the heating chamber 3 where the article to be heated S is mounted. A map of the temperature distribution inside the heating chamber is shown in FIG. 3. As can be seen in this figure, unevenness in the temperature inside the heating chamber 3 is reduced as compared with that of the conventional example. This makes it possible to apply heat uniformly to the article to be heated S as compared with the conventional structure.

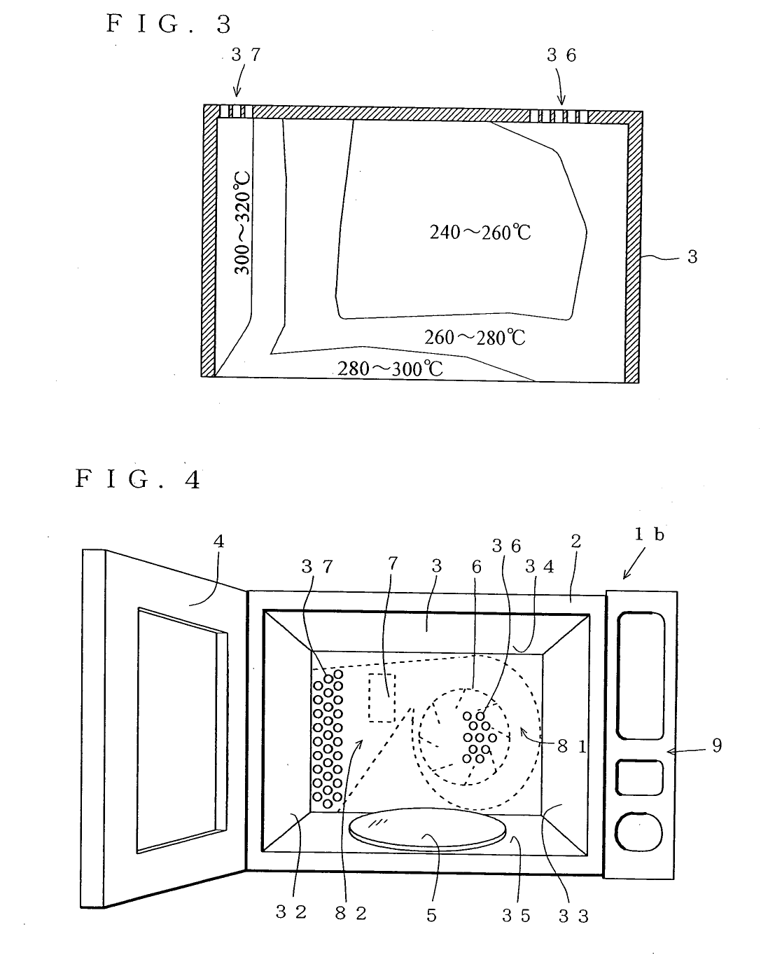

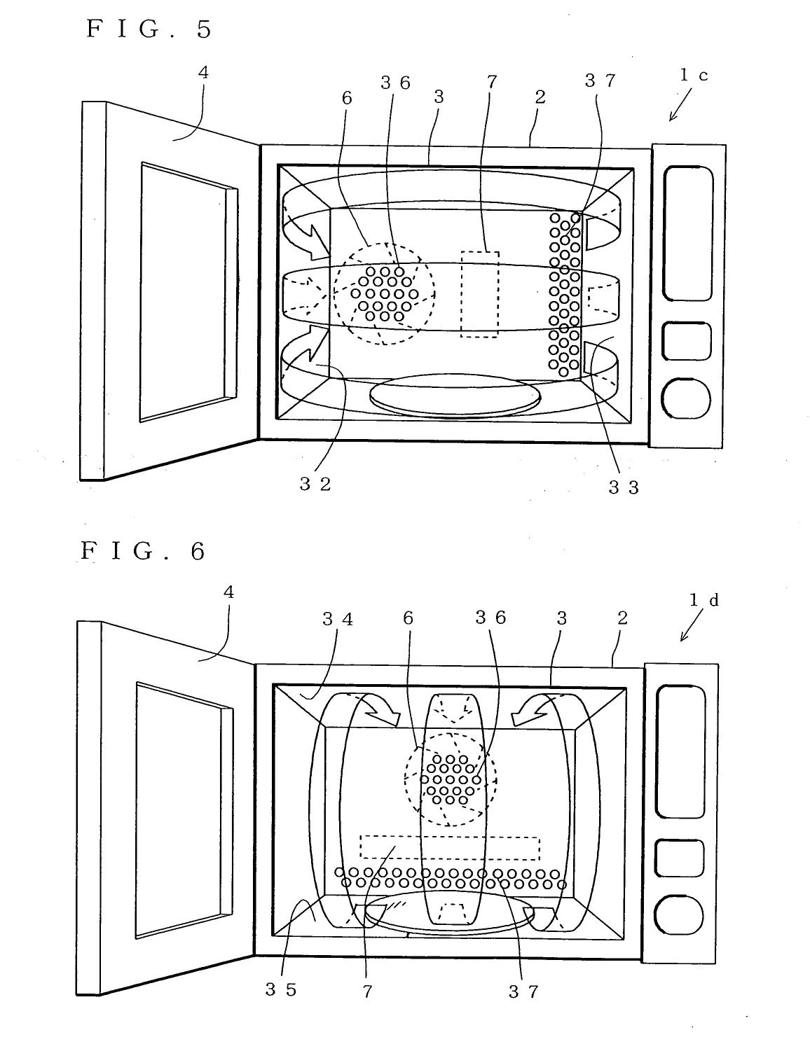

As another embodiment, as shown in FIG. 4, it is possible to form a scroll portion 81 and a diffuser portion 82 in the fan casing 8, so that the suction port 36 is further shifted to the right edge portion of the side wall 31 when viewed from the front. This makes it possible to send the air in a more appropriate manner, and thus apply heat more uniformly to the article to be heated S as compared with the conventional structure.

Although the suction port 36 and the blowoff port 37 may be formed elsewhere as long as the hot air that has been blown out flows along at least three inner walls, it is preferable that a blowoff port be formed in one edge portion of an inner wall, and that a suction port be formed in the opposite edge portion of the inner wall. For example, as shown in FIG. 5, unlike the heating cooker shown in FIG. 1, it is possible to form the suction port 36 in the left edge portion of the side wall 31 when viewed from the front, and the blowoff port 37 in the right edge portion thereof, so that the hot air flows along the right side wall 33, the inner wall of the door 4, and the left side wall 32 in the order in which they are mentioned. Moreover, as shown in FIG. 6, it is possible to form the suction port 36 in the edge portion of the side wall 31 on the side of the ceiling 34, and the blowoff port 37 in the edge portion thereof on the side of the bottom wall 35, so that the hot air flows along the bottom wall 35, the inner wall of the door 4, and the ceiling 34 in the order in which they are mentioned. As in the case of the heating cooker shown in FIG. 1, these structures make it possible to make the temperature inside the heating chamber 3 uniform. Furthermore, unlike conventional examples, it is possible to apply heat more uniformly to the article to be heated S as compared with the conventional structure while preventing the hot air from being concentrated at the center of the heating chamber 3 where the article to be heated S is mounted.

Note that the heating cooker of this invention may be additionally provided with a heating apparatus such as an electromagnetic wave heating apparatus, a dielectric heating apparatus, and a steam heating apparatus, so as to aid in cooking by the heater.

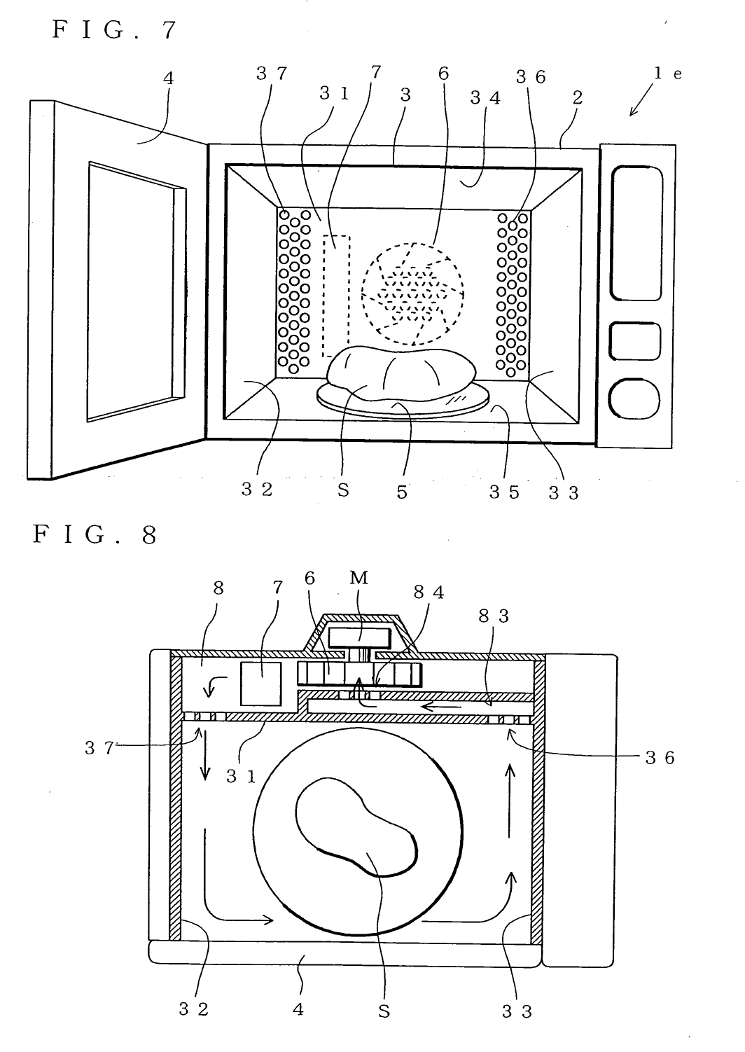

A front perspective view showing another embodiment of the heating cooker of the first invention is shown in FIG. 7, and a plan sectional view thereof is shown in FIG. 8. It is to be noted that such members and parts as are found also in the heating cooker of FIG. 1 are identified with common reference numerals and their detailed descriptions will be omitted. Now, the heating cooker 1e of FIG. 7 differs from the heating cooker 1a of FIG. 1 mainly in that it is provided with a stripe-shaped suction port 36 along the right side edge of the side wall 31 when viewed from the front. In the heating cooker 1a of FIG. 1, the suction port 36 cannot be formed in the vicinity of the side edge of the side wall 31, because there is a necessity to provide space so that the centrifugal fan 6 can rotate therein. Therefore, in the heating cooker 1e of FIG. 7, as shown in FIG. 8, by providing an air-blow passage 83 that allows the air to flow via the suction port 36 to the center of the centrifugal fan 6, the suction port 36 formed in the side wall 31 is made separate from an intake port 84 of the centrifugal fan 6. This makes it possible to provide a stripe-shaped suction port 36 along the side edge of the side wall 31 regardless of space where the centrifugal fan 6 rotates.

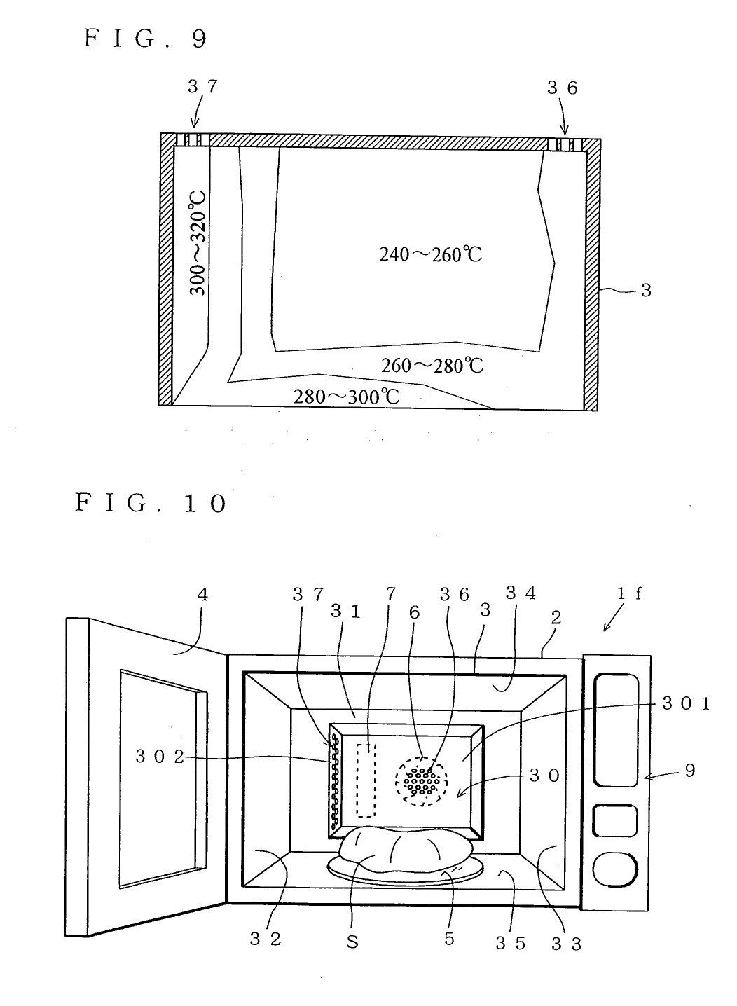

With this structure, the hot air inside the heating chamber 3 flows along the paths indicated by arrows in FIG. 8. Here, the stripe-shaped suction port 36 of the heating chamber 3 is formed along the right side edge of the side wall 31. This makes the hot air flow smoothly and orderly along the side wall 33 of the heating chamber 3 even in the vicinity of the suction port 36 of the heating chamber 3, creating a so-called laminar airflow, as compared with the heating cooker 1a of FIG. 1 having the suction port formed at the center, lengthwise, of the right side edge portion of the side wall 31. With this structure, as shown in FIG. 9, it is possible to make wider the same temperature range in the center of the heating chamber 3 when viewed in a plan view. This makes it possible to apply heat uniformly to the article to be heated S in a wider area.

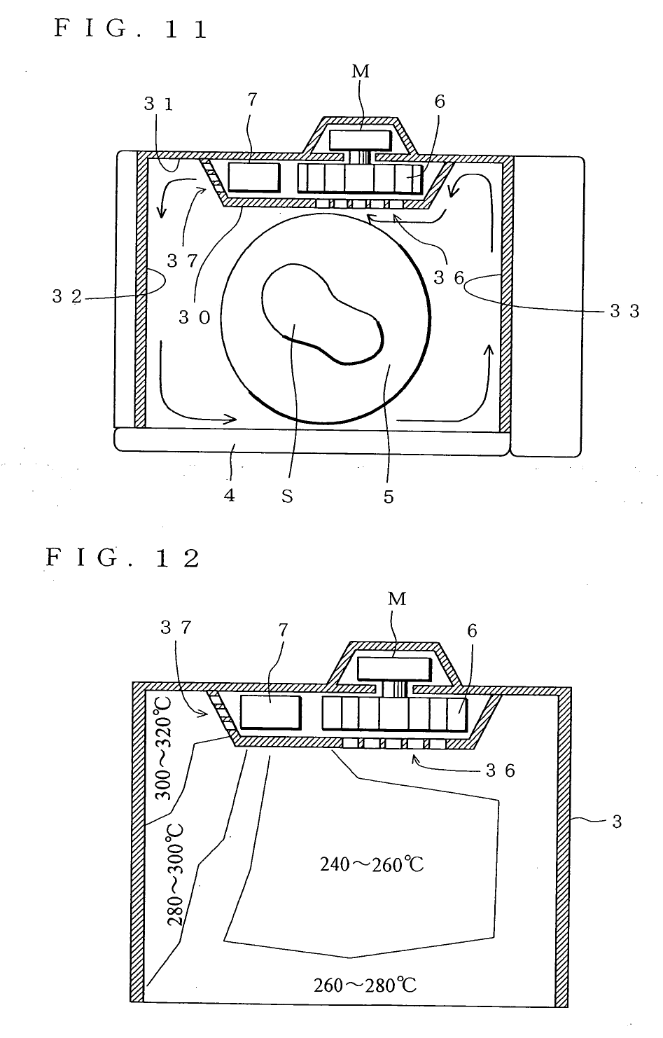

A front perspective view showing still another embodiment of the heating cooker of the first invention is shown in FIG. 10, and a plan sectional view thereof is shown in FIG. 11. It is to be noted that such members and parts as are found also in the heating cooker of FIG. 1 are identified with common reference numerals and their detailed descriptions will be omitted. Now, the heating cooker 1f of FIG. 10 differs from the heating cooker 1a of FIG. 1 mainly in that it is provided with, at substantially the center of the side wall 31, a projecting portion 30 having quadrangular bottom and top faces and having a cross-sectional area gradually decreasing from the bottom face toward the top face, and in that the projecting portion 30 has a top face 301 having the suction port 36 formed therein and a left side face 302 having the blowoff port 37 formed therein. As shown in FIG. 11, the centrifugal fan 6 and the heater 7 are accommodated in the projecting portion 30. With this structure, it is possible to make the heating cooker compact.

With this structure, the hot air inside the heating chamber 3 flows along the paths indicated by arrows in FIG. 11. Specifically, the hot air blown out through the blowoff port 37 formed in the projecting portion 30 flows a short distance along the side wall 31, and then flows continuously, by the Coanda effect, along the side wall 32, the door 4, and the side wall 33. Then, after flowing a short distance along the side wall 31, the hot air flows along the slope of the projecting portion 30, and is then sucked in via the suction port 36 of the projecting portion 30. Such a flow of hot air makes the air that has just been blown out through the blowoff port 37 and has a comparatively high temperature localized in the back left-hand comer of the heating chamber 3. This makes it possible, as shown in FIG. 12, to make wider the same temperature range in the center of the heating chamber 3 when viewed in a plan view, and thus apply heat uniformly to the article to be heated S in a wider area.

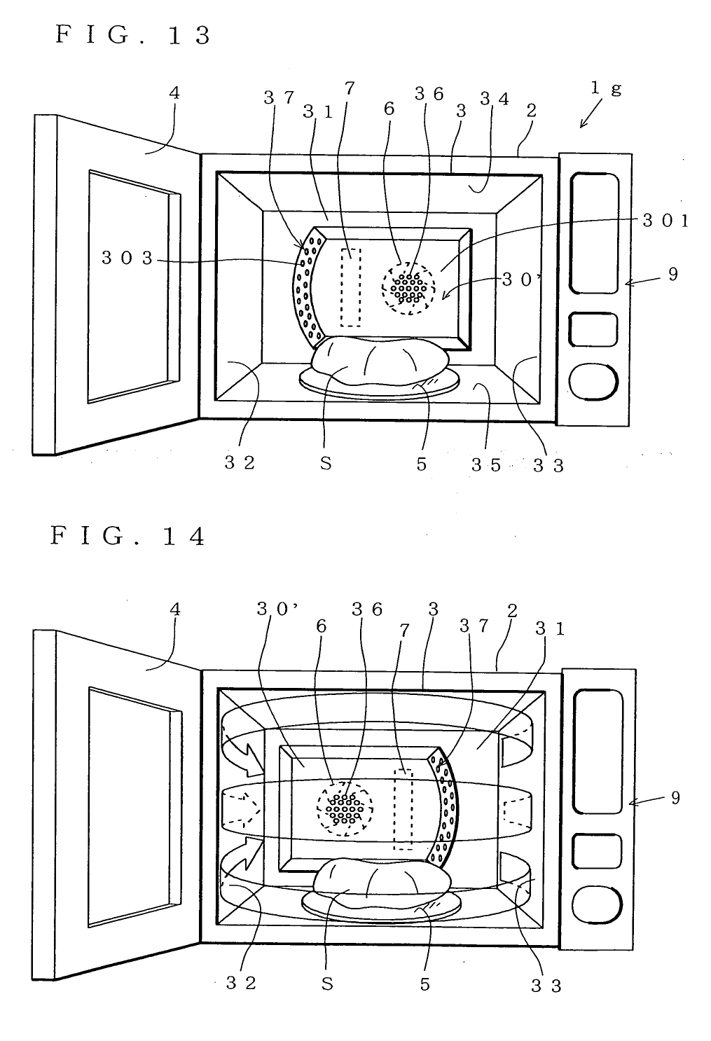

FIG. 13 is a front perspective view showing another example of the projecting portion formed in the side face 31. In this figure, the projecting portion 30′ differs from the embodiment described above in that it is provided with quadrangular bottom and top faces, one side of each being a circular arc, and having a cross-sectional area gradually decreasing from the bottom face toward the top face. The suction port 36 is formed in the top face 301 as in the embodiment described above. In this case, however, the blowoff port 37 is formed in the left side face 303 having a curved face. As described above, the blowoff port 37 is formed in the side face 303 having a curved face. Thus, the hot air is blown out through the blowoff port 37 at different angles with respect to the horizontal direction. This makes it possible to make the temperature inside the heating chamber 3 more uniform.

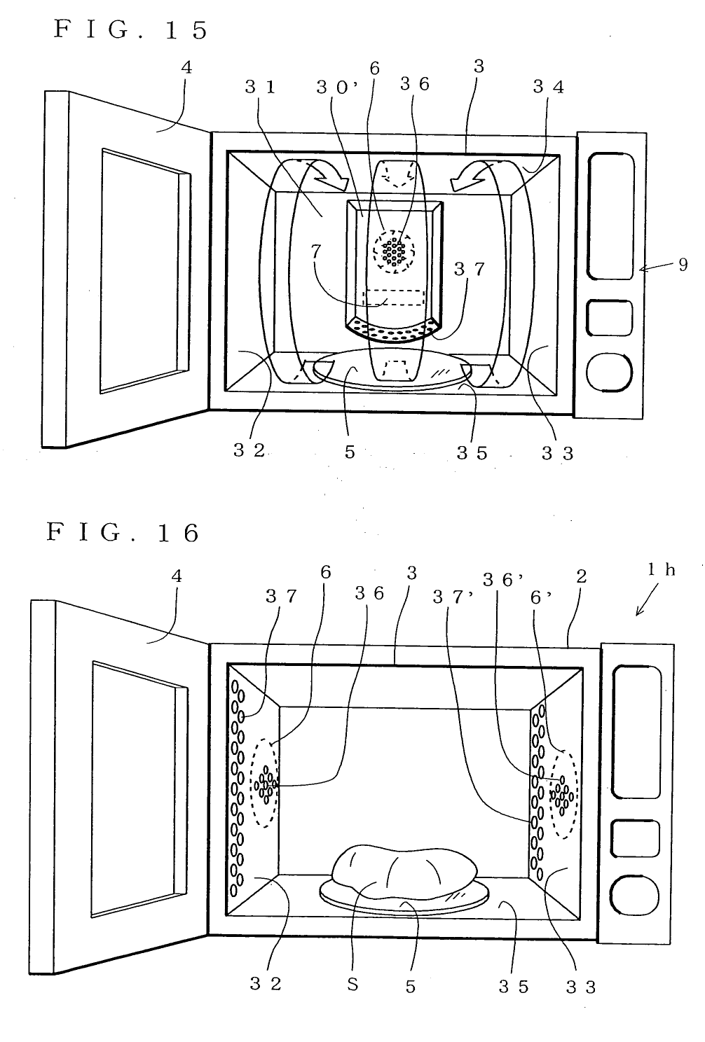

The embodiments described above deal with cases where the projecting portion is formed in the side wall 31. It should be understood, however, the projecting portion may be formed in the side wall 32 or 33, the ceiling 34, or the bottom wall 35. Moreover, the blowoff port 37 formed in the projecting portion may be formed anywhere in the side face of the projecting portion so long as the hot air that has been blown out flows continuously along at least three inner walls. For example, as shown in FIG. 14, unlike the heating cooker of FIG. 13, it is possible to form the blowoff port 37 on the right side face of the projecting portion 30′ when viewed from the front, so that the hot air flows along the right side wall 33, the inner wall of the door 4, and the left side wall 32 in the order in which they are mentioned. Moreover, as shown in FIG. 15, it is possible to form the blowoff port 37 in the lower side face of the projecting portion 30′ when viewed from the front, so that the hot air flows along the bottom wall 35, the inner wall of the door 4, and the ceiling 34 in the order in which they are mentioned. As in the case of the heating cooker of FIG. 13, unlike conventional examples, these structures make it possible to apply heat more uniformly to the article to be heated S as compared with the conventional structure while preventing the hot air from being concentrated at the center of the heating chamber 3 where the article to be heated S is mounted.

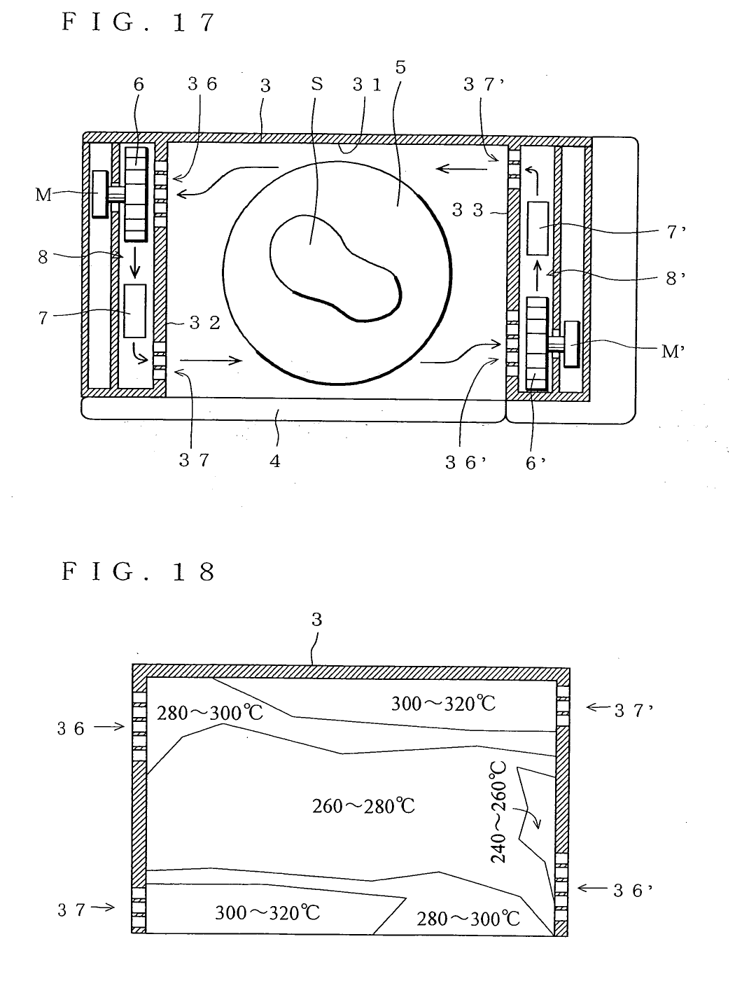

Next, a front perspective view showing one embodiment of the heating cooker of a second invention is shown in FIG. 16, and a plan sectional view thereof is shown in FIG. 17. It is to be noted that such members and parts as are found also in the heating cooker of FIG. 1 are identified with common reference numerals and their detailed descriptions will be omitted. Now, the heating cooker 1h of FIG. 16 differs from the heating cooker 1a of FIG. 1 mainly in that it is provided with, in the left side wall 32, the suction port 36 and the blowoff port 37, and, in the right side wall 33, the suction port 36′ and the blowoff port 37′ when viewed from the front, in such a way that the suction port 36 and the blowoff port 37 in the side wall 32 face the blowoff port 37′ and the suction port 36′ in the side wall 33, respectively, and, in addition, in that the centrifugal fan 6 and the heater 7 are formed behind the side wall 32 and the centrifugal fan 6′ and the heater 7′ are formed behind the side wall 33 (shown in FIG. 17).

With this structure, in the heating cooker 1h of FIG. 16, the hot air inside the heating chamber 3 flows along the paths indicated by arrows in FIG. 17. Specifically, the hot air blown out through the blowoff port 37 formed in the left side wall 32 flows, by the Coanda effect, to the right side wall 33 of the heating chamber 3 along the inner wall of the door 4, and is then sucked in via the suction port 36′ formed in the right side wall 33 into the fan casing 8′. The air thus sucked in is sent outward in the direction of the radius by the centrifugal fan 6′, is then heated by the heater 7′, and is then blown out through the blowoff port 37′ into the heating chamber 3. The hot air thus blown out into the heating chamber 3 flows as before, by the Coanda effect, to the left side wall 32 along the side wall 31, is then sucked in via the suction port 36 formed in the left side wall 32 into the fan casing 8, is then sent outward in the direction of the radius by the centrifugal fan 6, is then heated by the heater 7, and is then again blown out through the blowoff port 37 into the heating chamber 3.

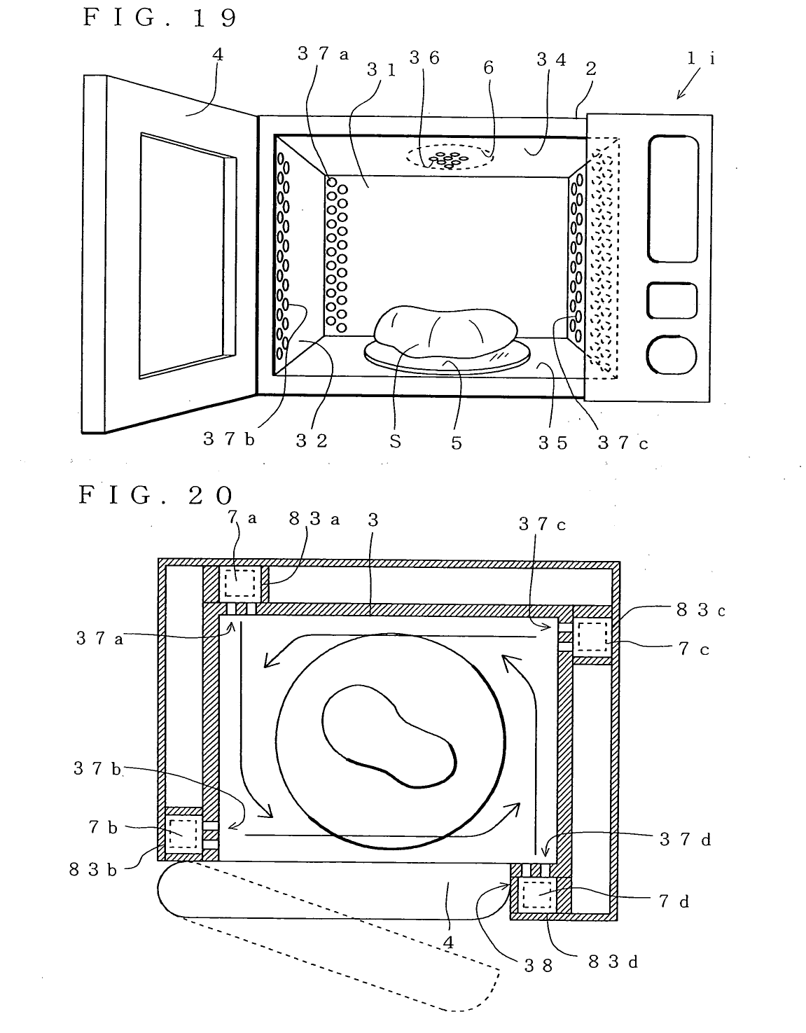

In that case, the hot air flowing in a circulating manner produces a symmetrical appearance with respect to the center of the heating chamber 3 in the depth direction when viewed in a plan view. Thus, as can be seen in FIG. 18 showing the temperature distribution map, it is possible to uniformly heat the heating chamber 3 also in the depth direction of the heating chamber 3. This makes it possible to apply heat uniformly to the article to be heated S especially in the depth direction as compared with the conventional structure.

Next, a heating cooker of a third invention will be described. The distinctive feature of the heating cooker of this invention is that the blowoff port is formed in the side wall of the heating chamber and the suction port is formed in at least one or both of the ceiling and the bottom wall, so that the hot air blown out through the blowoff port into the heating chamber flows inside the heating chamber in a spiral manner, and is then sucked in via the suction port. This structure makes it possible to uniformly heat the heating chamber, and apply heat uniformly to the article to be heated.

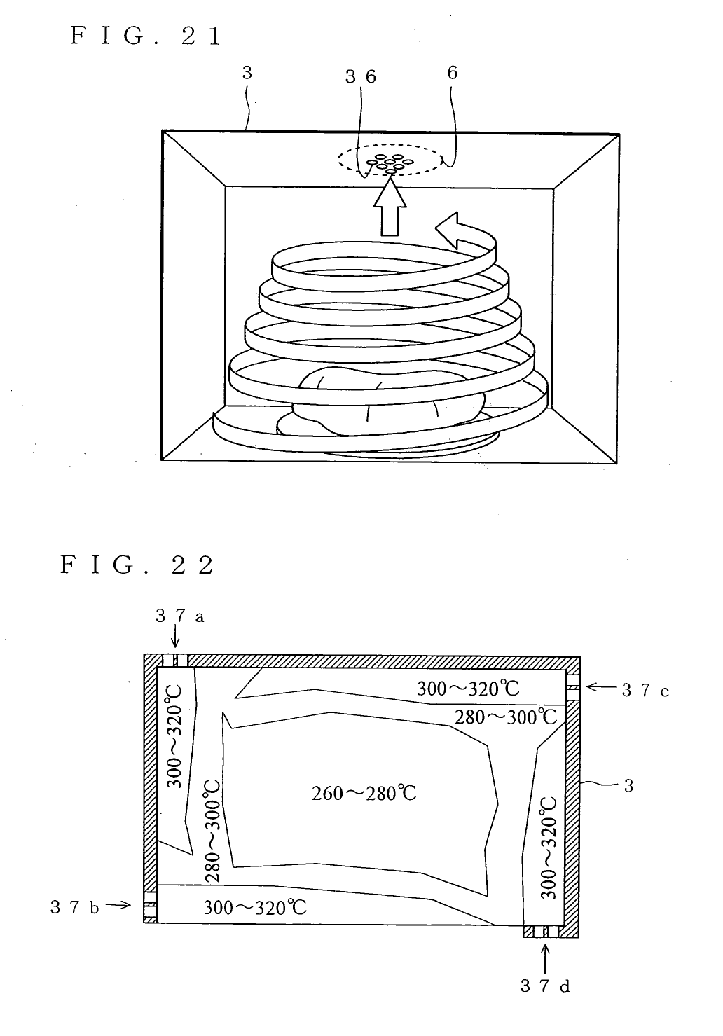

A front perspective view showing one embodiment of the heating cooker of this invention is shown in FIG. 19, and a plan sectional view thereof is shown in FIG. 20. It is to be noted that such members and parts as are found also in the heating cooker 1a of FIG. 1 are identified with common reference numerals and their detailed descriptions will be omitted. In the heating cooker 1i of FIG. 19, the suction port 36 is formed at substantially the center of the ceiling 34 of the heating chamber 3, and the side walls 31, 32, and 33 each have a stripe-shaped blowoff port 37a, 37b, or 37c, respectively, formed in a left edge portion thereof, parallel to the edge. Moreover, a strip-shaped blowoff port 37d is formed in a rim side wall 38 (see FIG. 20), which together with the door 4 in its closed state forms another side wall of the heating chamber 2, parallel to the edge thereof. The ceiling 34 has, at the back thereof, a fan casing (not shown), in which the centrifugal fan 6 is formed so as to face the suction port 36. This fan casing has air-blow passages 83a to 83d connected thereto for sending air to the blowoff ports 37a, 37b, 37c, and 37d, respectively. Inside these air-blow passages, there are respectively provided heaters 7a to 7d (see FIG. 20).

When cooking is started in the heating cooker 1i structured as described above, the air inside the heating chamber 3 is sucked in via the suction port 36 formed in the ceiling 34 into the fan casing by rotation of the centrifugal fan 6, and is then sent outward in the direction of the radius of the centrifugal fan 6. The air thus sent from the centrifugal fan 6 is sent to the blowoff ports 37a to 37d formed in the side walls of the heating chamber 3 through the air-blow passages 83a to 83d connected to the fan casing. On the way thereto, the air is heated by the heaters 7a to 7d provided inside the air-blow passages. Then, the hot air is blown out, into the heating chamber 3, through the blowoff ports 37a to 37d that are formed one in each of the side walls in an edge portion thereof at the same side. The hot air that has been blown out flows inside the heating chamber 3, by the Coanda effect around the side walls 31, 32, and 33 of the heating chamber 3 and the door 4, along the side walls and the door as indicated by arrows in FIGS. 20 and 21 in a spiral manner in the direction of the suction port 36 (produces a so-called tornado-like air current), and is then again sucked in via the suction port 36 into the fan casing.

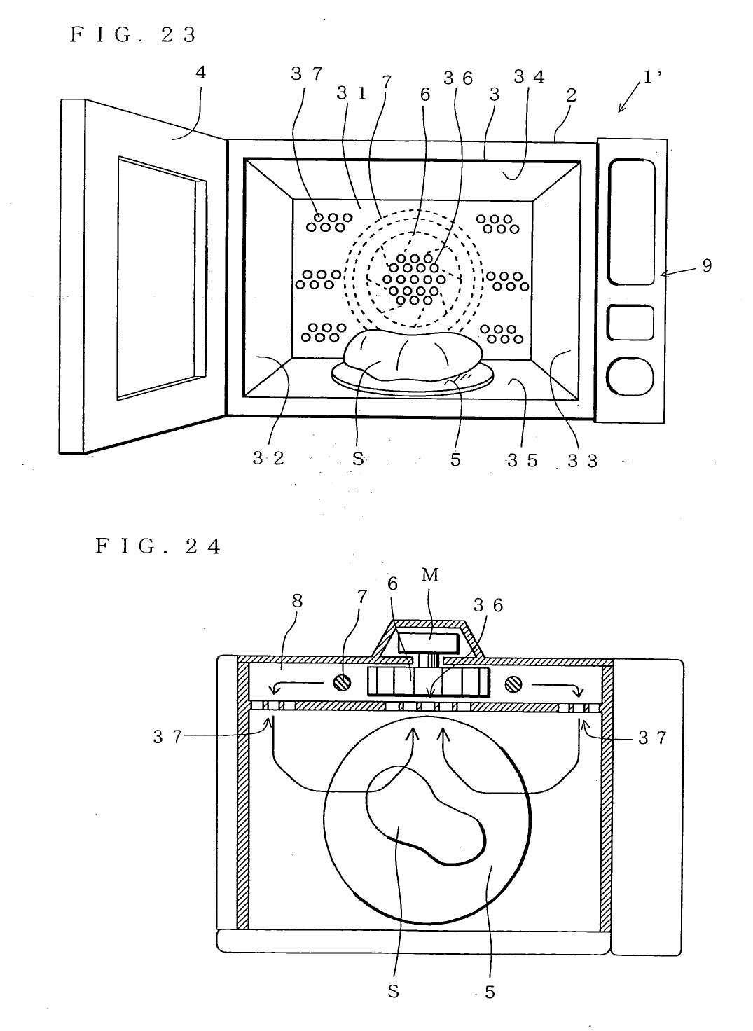

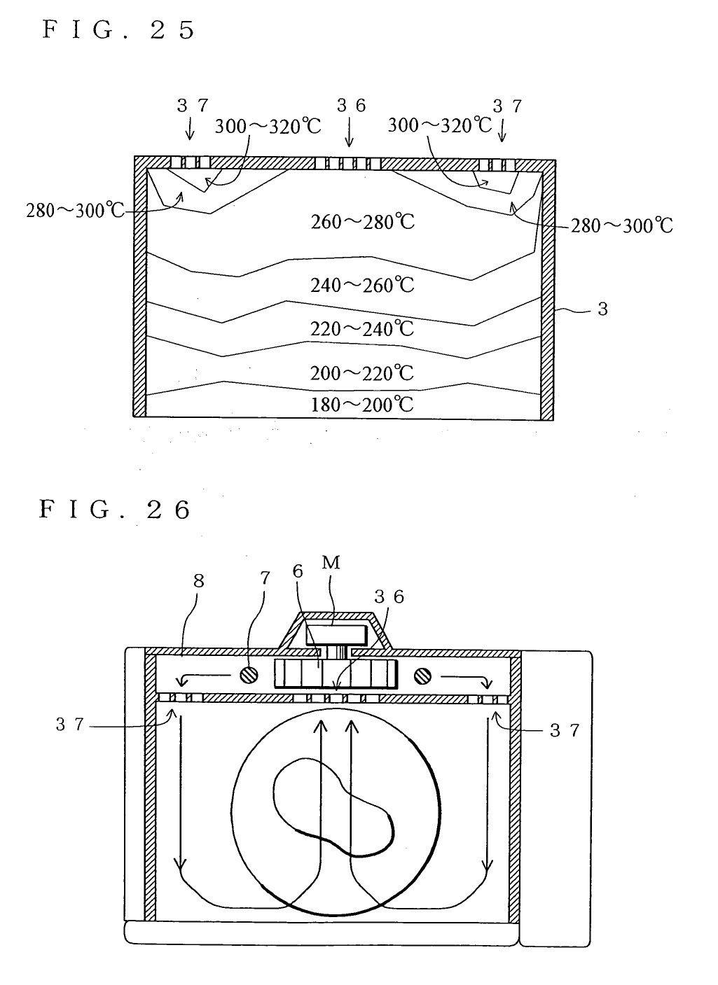

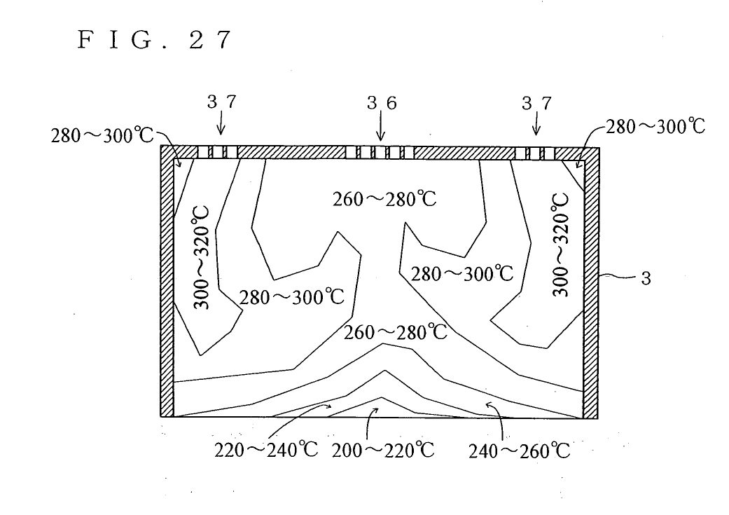

As can be seen in FIG. 22 showing the temperature distribution map, the hot air flowing in a circulating manner as described above makes the temperature distribution inside the heating chamber 3 produce a symmetrical appearance with respect to a point at the center of the heating chamber 3. This makes it possible to uniformly heat the center of the heating chamber 3 where the article to be heated S is mounted, and apply heat more uniformly to the article to be heated S as compared with the conventional structure.

The embodiment of FIG. 19 deals with a case where the interior of the heating chamber is quadrangular when viewed in a plan view. It should be understood, however, the side wall thereof may have the shape of a curved face. Moreover, any number of blowoff ports may be formed in any other position in the side walls so long as the air blown out through the blowoff port flows inside the heating chamber in a spiral manner, and is then sucked in via the suction port. Similarly, any number of suction ports may be formed in any other position in the ceiling and/or the bottom wall.

Moreover, in the above-described heating cookers of this invention, there is a danger of being burned by the hot air having a high temperature when the door is carelessly opened during cooking, because the hot air flows along the inner face of the door by the Coanda effect. To prevent this, it is needless to say that there is a necessity to provide a safety mechanism that turns the heater off, and, if necessary, turns the fan off when the door is opened by providing a means for detecting opening/closing of the door.

### INDUSTRIAL APPLICABILITY

As described above, a heating cooker according to the present invention can apply heat uniformly to an article to be heated by making a hot air spread to every corner of a heating chamber, and is therefore useful as a hot air circulation heating cooker.

1-3. (canceled)

4. A heating cooker, comprising:
a heating chamber that has a suction port and a blowoff port formed therein, and that accommodates an article to be heated;
blowing means that sucks in air inside the heating chamber via the suction port, and that then blows off the air through the blowoff port into the heating chamber so as to make the air circulate; and
heating means that heats the air sucked in via the suction port,
wherein there is formed, in at least one inner wall constituting an interior of the heating chamber, a projecting portion having quadrangular bottom and top faces when viewed in a plan view,
wherein the suction port is formed in a top face of the projecting portion,
wherein the blowoff port is formed in a side face thereof, and
wherein a hot air blown out through the blowoff port flows continuously along at least three inner walls constituting the heating chamber.

5. A heating cooker, comprising:
a heating chamber that has a suction port and a blowoff port formed therein, and that accommodates an article to be heated;
blowing means that sucks in air inside the heating chamber via the suction port, and that then blows off the air through the blowoff port into the heating chamber so as to make the air circulate; and
heating means that heats the air sucked in via the suction port,
wherein there is formed, in at least one inner wall constituting an interior of the heating chamber, a projecting portion with bottom and top faces each having a shape of a quadrangle, when viewed in a plan view, one side of the quadrangle being so shaped that a hot air is blown out therefrom at different angles with respect to a horizontal direction,
wherein the suction port is formed in the top face of the projecting portion,
wherein the blowoff port is formed in a side face of the projecting portion, the side face including the one side of the quadrangle, and
wherein a hot air blown out through the blowoff port flows continuously along at least three inner walls constituting the heating chamber.

6. The heating cooker of claim 5,
wherein, when viewed in a plan view, the bottom and top faces of the projecting portion each have a shape of a quadrangle, one side of the quadrangle is a circular arc.

7-10. (canceled)

11. The heating cooker of claim 4,
wherein the projecting portion has a cross-sectional area gradually decreasing from the bottom face thereof toward the top face thereof.

12. The heating cooker of claim 5,
wherein the projecting portion has a cross-sectional area gradually decreasing from the bottom face thereof toward the top face thereof.

13. The heating cooker of claim 6,
wherein the projecting portion has a cross-sectional area gradually decreasing from the bottom face thereof toward the top face thereof.
